(19) United States
(12) Patent Application Publication
(10) Pub. No.: US 2022/0108220 A1
(43) Pub. Date: Apr. 7, 2022

(54) Systems And Methods For Performing Automatic Label Smoothing Of Augmented Training Data

(71) Applicant: Google LLC, Mountain View, CA (US)

(72) Inventors: Yao Qin, Mountain View, CA (US); Alex Beutel, Mountain View, CA (US); Ed Huai-Hsin Chi, Palo Alto, CA (US); Xuezhi Wang, New York, NY (US); Balaji Lakshminarayanan, Mountain View, CA (US)

(21) Appl. No.: 17/493,228

(22) Filed: Oct. 4, 2021

Related U.S. Application Data
(60) Provisional application No. 63/086,913, filed on Oct. 2, 2020.

(51) Int. Cl. G06N 20/00

(52) U.S. Cl. CPC G06N 20/00

(57) ABSTRACT

Example aspects of the present disclosure are directed to systems and methods for performing automatic label smoothing of augmented training data. In particular, some example implementations of the present disclosure which in some instances can be referred to “AutoLabel” can automatically learn the labels for augmented data based on the distance between the clean distribution and augmented distribution. AutoLabel is built on label smoothing and is guided by the calibration-performance over a hold-out validation set. AutoLabel is a generic framework that can be easily applied to existing data augmentation methods, including AugMix, mixup, and adversarial training, among others. AutoLabel can further improve clean accuracy, as well as the accuracy and calibration over corrupted datasets. Additionally, AutoLabel can help adversarial training by bridging the gap between clean accuracy and adversarial robustness.

### RELATED APPLICATIONS

This application claims priority to and the benefit of U.S. Provisional Patent Application No. 63/086,913, filed Oct. 2, 2020. U.S. Provisional Patent Application No. 63/086,913 is hereby incorporated by reference in its entirety.

### FIELD

The present disclosure relates generally to machine learning. More particularly, the present disclosure relates to systems and methods for performing automatic label smoothing of augmented training data.

### BACKGROUND

Deep neural networks and other machine learning models are increasingly being used in high-stakes applications. Therefore, models should not only be accurate on expected test cases (independent and identically distributed samples), but also be robust to distribution shift and not be vulnerable to adversarial attacks.

Recent work has shown that the accuracy of state-of-the-art models drops significantly when tested on corrupted data. Furthermore, these models are not just wrong on these unexpected examples, but also overconfident. For example, recent work has shown that calibration of models degrades under shift. Calibration measures the gap between a model's own estimate of correctness (a.k.a. confidence) versus the empirical accuracy which measures the actual probability of correctness. Thus, building models that are accurate and robust, i.e. can be trusted under unexpected inputs from both distributional shift and adversarial attacks, is a challenging research problem, central to trusting models for deployment in high-stakes settings.

Existing work has shown that data augmentation can improve both accuracy and generalization performance for a neural network or other machine learning model. In particular, improving both calibration under distribution shift and adversarial robustness has been the focus of numerous research directions. While there are many approaches to addressing these problems, one of the fundamental building blocks is data augmentation: generating synthetic examples, typically by modifying existing training examples, that provide additional training data outside the empirical training distribution. A wide breadth of literature has explored what are effective ways to modify training examples, such as making use of domain knowledge through label-preserving transformations or adding adversarially generated, imperceptible noise. Approaches like these have been shown to improve the robustness and calibration of overparametrized neural networks as they alleviate the issue of neural networks overfitting to spurious features that do not generalize beyond the i.i.d. test set.

However, augmented data is often noisier and it is not always clear what the appropriate label is for an augmented example. Despite this, most existing work simply reuses the original label from the clean data. Thus, the label space accompanying the augmented data has not been sufficiently explored.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method to improve robustness of machine learning models via automatic label smoothing of augmented training data. The method includes obtaining, by a computing system comprising one or more computing devices, a plurality of augmented examples, wherein each augmented example comprises a training label, wherein a first subset of the augmented examples are included in a training dataset and a second subset of the augmented examples are included in a validation dataset, wherein a respective distance measure is associated with each augmented example, and wherein the respective distance measure for each augmented example describes an amount of augmentation performed to generate the augmented example. The method includes partitioning, by the computing system, the plurality of augmented examples into a plurality of groups based on their respective distance measures. The method includes, for each of one or more training iterations: evaluating, by the computing system, a respective calibration value for each group that describes a calibration of a machine-learned model relative to the augmented examples included in the validation dataset and the group; and smoothing, by the computing system, the training label of each augmented example included in the training dataset by a respective smoothing amount that is based at least in part on the respective calibration value evaluated for the group in which the augmented example is included.

Another example aspect of the present disclosure is directed to a computing system—to improve robustness of machine learning models via automatic label smoothing of augmented training data. The computing system includes one or more processors and one or more non-transitory computer-readable media that collectively store instructions that, when executed by the one or more processors, cause the computing system to perform operations. The operations include obtaining, by a computing system comprising one or more computing devices, a plurality of augmented examples, wherein each augmented example comprises a training label, wherein a respective distance measure is associated with each augmented example, and wherein the respective distance measure for each augmented example describes an amount of augmentation performed to generate the augmented example. The operations include partitioning, by the computing system, the plurality of augmented examples into a plurality of groups based on their respective distance measures. The operations include, for each of one or more training iterations: evaluating, by the computing system, a respective calibration value for each group that describes a calibration of a machine-learned model relative to augmented examples included in the group; and smoothing, by the computing system, the training label of each of one or more of the augmented examples by a respective smoothing amount that is based at least in part on the respective calibration value evaluated for the group in which the augmented example is included.

Another example aspect of the present disclosure is directed to one or more non-transitory computer-readable media that collectively store: a machine-learned model that has been trained on a training dataset that includes a plurality of augmented examples having smoothed training labels; wherein the smoothed training label for each augmented example was smoothed by a respective smoothing amount based on a calibration metric evaluated for the machine-learned model relative to augmented examples included in a same group of a plurality of groups; and wherein the plurality of groups are defined based on respective distance measures for the augmented examples that describe an amount of augmentation performed to generate the augmented example.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a process for automatically smoothing training labels for augmented examples according to example embodiments of the present disclosure.

FIG. 2 depicts a flow chart of an example method to smooth training labels according to example embodiments of the present disclosure.

FIG. 3A depicts a block diagram of an example computing system according to example embodiments of the present disclosure.

FIG. 3B depicts a block diagram of an example computing device according to example embodiments of the present disclosure.

FIG. 3C depicts a block diagram of an example computing device according to example embodiments of the present disclosure.

Reference numerals that are repeated across plural figures are intended to identify the same features in various implementations.

### DETAILED DESCRIPTION

### Overview

Example aspects of the present disclosure are directed to systems and methods for performing automatic label smoothing of augmented training data. In particular, some example implementations of the present disclosure which in some instances can be referred to “AutoLabel” can automatically learn the labels for augmented data based on the distance between the clean distribution and augmented distribution. AutoLabel is built on label smoothing and is guided by the calibration-performance over a hold-out validation set. AutoLabel is a generic framework that can be easily applied to existing data augmentation methods, including AugMix, mixup, and adversarial training, among others. Example experiments contained in U.S. Provisional Patent Application No. 63/086,913 on CIFAR-10, CIFAR-100 and ImageNet show that AutoLabel can further improve clean accuracy, as well as the accuracy and calibration over corrupted datasets. Additionally, AutoLabel can help adversarial training by bridging the gap between clean accuracy and adversarial robustness.

More particularly, in the broad amount of research on data augmentation, most of it attempts to apply transformations that do not change the true label. Stated differently, many existing data augmentation techniques simply assume that the label of the original example should also be used as the label of the transformed example, without expensive manual review. Thus, while there has been a significant amount of work in how to construct such pseudo-examples in input space, there has been relatively little attention on whether this assumption of label-preservation holds in practice and what label should be assigned to such augmented inputs. For instance, many popular methods assign one-hot targets to both training data as well as augmented inputs. These one-hot targets can be quite far away from the training data, as evidenced by human feedback which demonstrates less than 100% confidence. Using one-hot encodings that do not reflect the uncertainty in the training examples runs the risk of adding noise to the training process and degrading accuracy.

With this observation, the present disclosure investigates the choice of target labels for augmented inputs and provides systems and methods that automatically adapt the confidence assigned to augmented labels, assigning high confidence to inputs close to the training data and lowering the confidence as we move farther away from the training data. Thus, one example aspect of the present disclosure is directed to a distance-based approach where the training labels for augmented examples are smoothed to different extents based on the distance between the augmented data and the clean data.

The proposed systems and methods are complementary to methods which focus on generating augmented inputs. In particular, the proposed framework can easily be combined with popular methods for data augmentation, such as AugMix (Hendrycks et. al, Augmix: A simple data processing method to improve robustness and uncertainty. In ICLR 2020), mixup (Zhang et al., Mixup: Beyond empirical risk minimization. In ICLR 2018), adversarial training (e.g., Goodfellow et al. Explaining and harnessing adversarial examples. In ICLR 2014), and others. Example experiments contained in U.S. Provisional Patent Application No. 63/086,913 show that the proposed methods significantly improve the calibration of models (and accuracy, although to a lesser extent) on both clean and corrupted data for CIFAR10, CIFAR100 and ImageNet. In addition, the proposed systems and methods also help bridge the gap between accuracy and adversarial robustness.

In some implementations, the proposed label smoothing techniques can be provided as a cloud service available to various users of cloud-based machine learning platform. For example, a user can supply or otherwise specify a set of clean and/or augmented examples. The processes described herein can then be performed to automatically smooth labels associated with the augmented examples specified by the user or generated from the clean examples specified by the user. For example, the automatic label smoothing can be performed in conjunction with model training as a service. The trained model can be provided as an output to the user (e.g., automatically deployed on behalf of or to one or more devices associated with the user).

The systems and methods of the present disclosure provide a number of technical effects and benefits. As one example technical effect, the proposed techniques improve machine learning model accuracy and calibration on clean data. In particular, empirical data demonstrates the proposed techniques consistently result in improved model accuracy and calibration across different datasets. Thus, the proposed techniques improve the performance of a computing system itself.

As another example technical effect, the proposed techniques improve model robustness under distributional shifts. In particular, while top-line improvements on accuracy are valuable, empirical data also shows that the proposed techniques significantly improve both model accuracy and calibration under distribution shifts. As yet another example technical effect, the proposed techniques reduce the necessary trade-off between adversarial robustness and accuracy.

As another example technical effect, the proposed techniques make data augmentation techniques more feasible and broadly applicable in or to different settings. This allows greater use of data augmentation techniques which allow training with less data, thereby conserving computing resources such as memory and processor usage. In addition, the proposed techniques make the resulting machine learning models more resistant to adversarial attack and reduce unpredictable, unsafe behavior exhibited by the resulting models. The enabling of use of more diverse training data results in more secure inference.

Thus, systems and methods are provided which automatically adapt labels for augmented data, with benefits for both model accuracy and calibration, compared to reusing one-hot labels as in many existing data augmentation works. The distance between the augmented data and the clean data is intelligently used to control the adaption of the labels in an automatic calibration-guided approach. The effectiveness of example implementations of AutoLabel are empirically demonstrated under three representative data augmentation methods: AugMix, mixup, and adversarial training. AutoLabel greatly improves the calibration over both clean data and corrupted data, and also helps adversarial training with a better trade-off between clean accuracy and adversarial robustness.

With reference now to the Figures, example embodiments of the present disclosure will be discussed in further detail.

### Example Label Smoothing Process

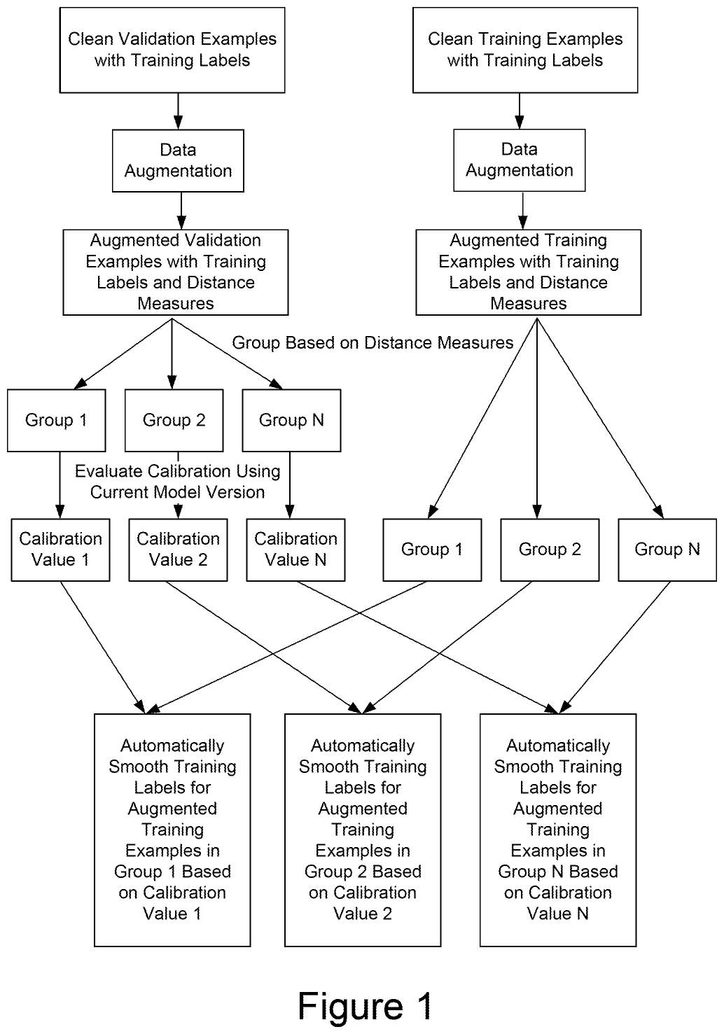

FIG. 1 depicts a process for automatically smoothing training labels for augmented examples according to example embodiments of the present disclosure. A dataset can include clean validation examples with training labels and clean training examples with training labels. One or more data augmentation techniques can be performed on the clean validation examples to generate augmented validation examples. A respective distance measure can be associated with each augmented validation example. The respective distance measure can indicate an amount of augmentation that was applied to the corresponding example during data augmentation. Similarly, one or more data augmentation techniques can be performed on the clean training examples to generate augmented training examples. A respective distance measure can be associated with each augmented training example. The respective distance measure can indicate an amount of augmentation that was applied to the corresponding example during data augmentation.

The augmented validation examples and the augmented training examples can be grouped into a plurality of groups based on their respective distance measures. For example, each group can contain examples that have a similarly valued distance measure. There can be any number of groups. Generally, a correspondence is defined between each validation group and each training group. For example, the correspondence can be one to one. The bounds of each validation group can be the same as or different from the bounds of a corresponding training group, and vice versa.

A calibration value can be evaluated for each group of augmented validation examples using a current version of a machine learning model. For example, the calibration value can be evaluated using an Expected Calibration Error metric. The training labels for the augmented training examples included in each training group can be automatically smoothed based on the calibration value(s) determined for the corresponding validation group(s). For example, the training label for each augmented training example included in training group 1 can be automatically smoothed based on the calibration value evaluated for the validation group 1.

After performing the label smoothing, the machine learning model can be re-trained using the smoothed labels. Thereafter, the process can optionally return to the step of evaluating the calibration value for each group (e.g., using the re-trained model).

Although two separate dataset (training and validation are shown), in some implementations, the method can be performed using the same dataset (e.g., only a training dataset).

### Example Methods

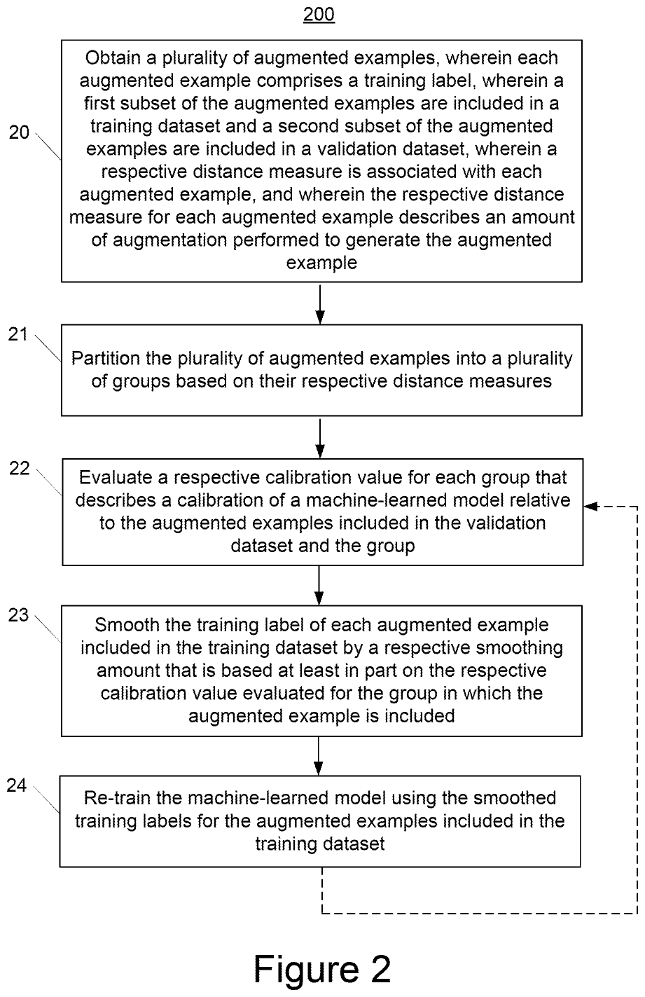

FIG. 2 depicts a flow chart diagram of an example method 200 to perform according to example embodiments of the present disclosure. Although FIG. 2 depicts steps performed in a particular order for purposes of illustration and discussion, the methods of the present disclosure are not limited to the particularly illustrated order or arrangement. The various steps of the method 200 can be omitted, rearranged, combined, and/or adapted in various ways without deviating from the scope of the present disclosure.

Method 200 can begin at Block 20. Block 20 can include obtaining, by a computing system comprising one or more computing devices, a plurality of augmented examples, wherein each augmented example comprises a training label, wherein a first subset of the augmented examples are included in a training dataset and a second subset of the augmented examples are included in a validation dataset, wherein a respective distance measure is associated with each augmented example, and wherein the respective distance measure for each augmented example describes an amount of augmentation performed to generate the augmented example.

In some implementations, the respective distance measure for each augmented example can equal or be based on a number of augmentation operations performed to generate the augmented example.

In some implementations, the respective distance measure for each augmented example equal or be based on a mixing parameter that controls an amount of mixing between two inputs that are combined to generate the augmented example.

In some implementations, the respective distance measure for each augmented example equal or be based on a norm of an adversarial perturbation performed to generate the augmented example.

Block 21 can include partitioning, by the computing system, the plurality of augmented examples into a plurality of groups based on their respective distance measures. In some implementations, the number of groups can be a user-specified hyper-parameter. In some implementations, the number of groups can be adaptively learned (e.g., based on clustering techniques).

Block 22 can include evaluating, by the computing system, a respective calibration value for each group that describes a calibration of a machine-learned model relative to the augmented examples included in the validation dataset and the group. In some implementations, evaluating, by the computing system and for each group, the respective calibration value for each group comprises evaluating, by the computing system and for each group, a respective Expected Calibration Error metric.

Block 23 can include smoothing, by the computing system, the training label of each augmented example included in the training dataset by a respective smoothing amount that is based at least in part on the respective calibration value evaluated for the group in which the augmented example is included.

In some implementations, smoothing, by the computing system, the training label of each augmented example included in the training dataset can include: reducing, by the computing system, a label value provided by the training label for a true class when the machine-learned model is overconfident on the validation dataset; and increasing, by the computing system, the label value provided by the training label for the true class when the machine-learned model is underconfident on the validation dataset.

As an example, in some implementations, each training label can include a plurality of label values respectively for a plurality of output classes. In some of such examples, smoothing, by the computing system, the training label of each augmented example included in the training dataset can include modifying, by the computing system, the label value for a true class of the plurality of output classes by the respective smoothing amount.

In some implementations, the respective smoothing amount for each augmented example included in the training dataset can include the respective calibration value evaluated for the group in which the augmented example is included times a scaling coefficient times a sign function applied to a confidence measure evaluated for the group minus an accuracy measure evaluated for the group.

In some implementations, the smoothing process can further include performing, by the computing system, a clipping operation to ensure that the smoothed training label for each augmented example included in the training dataset is within a range extending from an accuracy measure evaluated for the group in which the augmented example is included to one.

Block 24 can include re-training, by the computing system, the machine-learned model using the smoothed training labels for the augmented examples included in the training dataset.

After Block 24, the method can optionally return to 22 or can optionally output the trained model as an output.

### Example Notation and Calibration Metric

Example Notations

Given a clean dataset [symbol] ={(xᵢ, yᵢ)}_{i=1, . . . , m}, example implementations consider a classifier f(⋅) for a K-class classification problem, where y∈{1, . . . , K}. The one-hot encoding of the label can be denoted as ŷ∈{0,1}^{K}, where the label for the true class ŷ_{k=y}=1 and ŷ_{k≠y}=0 for others. Let fₖ(x) denote the predicted probability for the k-th class. Example implementations use f(x):=argmaxₖfₖ(x) to represent the predicted class and c(x):=maxₖfₖ(x) as model's confidence of the predicted class. For notational convenience, in addition to the training data [symbol] , portions of this discussion assume example implementations also have a clean validation set [symbol] _{V}={(x′ᵢ, y′ᵢ)}_{i=1, . . . , m}_{_{V}} drawn i.i.d. from the same distribution.

Example Expected Calibration Error (ECE)

Example implementations use Expected Calibration Error (ECE) to measure a model's calibration performance. This metric measures how well aligned the average accuracy and the average predicted confidence conf, after dividing the input data into R buckets:

$$ECE = {\sum }_{r}^{R} \frac{\vert {B}_{r} \vert}{m} \vert acc ( {B}_{r} ) - conf ( {B}_{r} ) \vert ,$$

where Bᵣ indexes the r-th confidence bucket and m denotes the data size, the accuracy and the confidence of Bᵣ are defined as

$$a c c ( {B}_{r} ) = \frac{1}{\vert {B}_{r} \vert} {\sum }_{i ∈ {B}_{r}} 1 ( f ( {x}_{i} ) = {y}_{i} ) and conf ( {B}_{r} ) = \frac{1}{\vert {B}_{r} \vert} {\sum }_{i ∈ {B}_{r}} c ( {x}_{i} ) . \qquad$$

### Example Algorithms

Data augmentation has been shown to improve models' generalization. However, augmented data is often noisier and can be away from the original distribution at different distances. Despite this, most existing work simply uses the one-hot label for augmented data without differentiation, resulting in the label given and the true label do not agree exactly. To address this, example implementations propose AutoLabel to learn different labels for augmented data based on their distance to the clean distribution. This section will first discuss the general AutoLabel algorithm and then discuss how it can be applied to three different data augmentation techniques.

Example Implementations of AutoLabel

Given a data augmentation technique Aug that takes in an example x and outputs a transformed version, example implementations of AutoLabel can be mainly composed of two components: (1) a measure of the transformation distance from the original input example, and (2) a subroutine for updating labels of the augmented examples during training. As many data augmentation approaches have hyperparameters that reflect how large the transformation should be; example implementations refer to this as the transformation distance S. As examples, this can take the form of the number of transformations in Augmix or the norm of the adversarial perturbation in. Together, example implementations use Aug(x, S) to denote the generation of a transformed example.

One valuable insight is that the confidence in the labels associated with the augmented data likely depends on how significant the transformation is. To make use of this insight, example implementations assign different labels for the augmented training data based on their transformation distances. The labels can be updated according to the calibration of the model on the augmented validation data. To this end, example implementations can split both the training data and validation data into buckets for measuring calibration. Here, example implementations will discretize the transformation distance S into N buckets {S₁, . . . , S_{N}}. Thus, Aug(x, Sₙ) would denote a transformation of input x by a distance in bucket Sₙ.

In order to learn the label \tilde{y}(Sₙ) for the augmented training data Aug(x, Sₙ), AutoLabel constructs an augmented validation set Q(Sₙ)={(Aug(x′ᵢ,Sₙ),y′ᵢ)|(x′ᵢ,y′ᵢ)∈ [symbol] _{V}} by performing the same augmentation technique on the validation set. After that, AutoLabel updates the label for the true class \tilde{y}_{k=y}(Sₙ) based on the calibration performance on the augmented validation set Q(Sₙ) after each training epoch t:

\tilde{y}_{k=y}^{t+1}(Sₙ)=\tilde{y}_{k=y}^{t}(Sₙ)−α·ECE^{t}(Q(Sₙ))·sign(Conf^{t}(Q(Sₙ))−Acc^{t}(Q(Sₙ))) (1)

where ECE(Q(Sₙ)) is the expected calibration error on the augmented validation set, Acc(Q(Sₙ)) and Conf(Q(Sₙ)) are the accuracy and confidence on the augmented validation set, defined as:

Acc(Q(Sₙ))= [symbol] [1(f(Aug(x′,Sₙ))=y′)]

Conf(Q(Sₙ))= [symbol] [c(Aug(x′,Sₙ))]. (2)

The sign of (Conf(Q)−Acc(Q)) indicates if the model is overall over-confident (>0) or under-confident (<0). Intuitively, if the model is overconfident on the validation set, example implementations can reduce the label given to the true class \tilde{y}_{k=y}, otherwise example implementations can increase \tilde{y}_{k=y}. The expected calibration error on the augmented validation set ECE(Q)∈[0, ∞) suggests to what extent one should adjust the labels as the optimal result is ECE(Q)=0 when the training converges. The hyperparameter α controls the step size of updating the labels. Since \tilde{y}_{k=y}^{t+1} stands for the probability of the true class, example implementations clip the value to be within [Acc^{t}(Q),1] after each update. Acc^{t}(Q) is used as the minimum clipping value to prevent \tilde{y}_{k=y}^{t+1} from being too small as

$$A c {c}^{t} ( Q ) \to \frac{1}{K}$$

when the classifier is a random guesser.

Once the updated label for the true class \tilde{y}_{k=y}^{t+1} is obtained, the labels for other classes can be uniformly distributed:

$${\tilde{y}}_{k \neq y}^{t + 1} = ( 1 - {\tilde{y}}_{k = y}^{t + 1} ) \cdot \frac{1}{K - 1} , \qquad ( 3 )$$

where K is the number of classes in the dataset and Σₖ₌₁^{K}\tilde{y}ₖ=1.

Finally, AutoLabel can the model using ý(Sₙ) as the target for the cross-entropy loss:

[symbol]

(Aug(x,Sₙ),\tilde{y}(Sₙ)). (4)

AutoLabel can easily slot into existing data augmentation methods and further improve model's generalization and robustness. The following sections demonstrate how to apply AutoLabel to learn more appropriate labels over three representative data augmentation methods:
AugMix: Mixing diverse simple augmentations in convex combinations.
Mixup: A linear interpolation of random clean images.
Adversarial Training: A special case of data augmentation to improve adversarial robustness.

Table 1 shows an overview of how AutoLabel differentiates the augmented data based on the transformation distance under each data augmentation method.

TABLE 1
Distance measure under various data augmentation methods used by
AutoLabel.

| Augmentation Method | AugMix | mixup | Adv. Training |
|---|---|---|---|
| Distance determined by | depth of augmentation chain d, | mixing parameter γ | max [symbol] _{∞} norm ϵ |
| | mixing parameter λ | | |
| Distance buckets | S_{d}_{₁}_{┌λN┐} | S_{┌2N·(min(γ,1-γ))┐} | ${S}_{⌈ ϵ \cdot \frac{N}{{e}_{m ax}} ⌉}$ |

### Example AutoLabel for AugMix

Example Overview of AugMix:

AugMix augments the input data via feeding the input x into an augmentation chain which consists of d∈{1,2,3} augmentations randomly sampled from a set of diverse augmentation operations, e.g., color, sheer, translation. Then a convex combination is performed to mix the augmented image x_{aug} with the original image x to get the final result:

Aug_{augmix}(x)=λ·x+(1−λ)·x_{aug} (5)

where the mixing parameter λ∈[0,1] is randomly sampled from a uniform distribution. The model is trained on the augmented data pairs {(Aug_{augmix}(x), ŷ)}, where ŷ is the one-hot encoding of the label associated with the original image.

The original AugMix uses 3 augmentation chains and then further mix the results from each of the augmentation chain via convex combinations. However, experimentation consistently observed an accuracy increase when one augmentation chain was used. Therefore, example experiments simplified AugMix with one augmentation chain.

Example Transformation Distance:

In AugMix, the transformation distance is controlled by two parameters:
the depth of the augmentation chain d: this decides how many augmentation operations are applied to the original image;
the mixing parameter λ in Eqn(5), this controls the ratio of the augmented image x_{aug} and the original image x.

Example Update Labels

To learn the labels for augmented training data that are within a distance bucket Sₙ to the clean distribution, AutoLabel constructs an augmented validation set Q(Sₙ) by feeding the validation images into an augmentation chain with the depth d and then randomly sample a mixing parameter λ′ from a uniformly distribution:

$${λ}^{′} \text{∼} 𝒰 ( \frac{λ N}{N} , \frac{λ N + 1}{N} )$$

to mix the original image and the augmented image as Eqn (5). Finally, AutoLabel updates the labels \tilde{y}(d) for the augmented training data that within a distance of Sₙ according to Eqn (1) and Eqn (3) and train the model using Eqn (4).

### Example AutoLabel for Mixup

Example Overview of Mixup

Mixup is originally proposed in that can consistently improve classification accuracy and further shown to be able to help with calibration in. Specifically, the input data as well as their labels are augmented by

Augₘᵢₓᵤₚ(xᵢ,xⱼ)=γxᵢ+(1−γ)xⱼ

Augₘᵢₓᵤₚ(yᵢ,yⱼ)=γŷᵢ+(1−γ)ŷⱼ (6)

where xᵢ and xⱼ are two randomly sampled input data and ŷᵢ and ŷⱼ are their associated one-hot labels. The model is trained with the standard cross-entropy loss [symbol] (f(xₘᵢₓᵤₚ), yₘᵢₓᵤₚ) and the mixing parameter γ∈[0,1] that determines the mixing ratio is randomly sampled from a Beta distribution Beta(β, β) at each training iteration. Rather than using the same mixing parameter γ to combine the labels, AutoLabel can be applied to automatically learn its labels yₘᵢₓᵤₚ based on the validation calibration.

Example Transformation Distance:

The transformation distance in mixup is determined by the mixing parameter γ in Eqn (6). When γ→0.5, combining two images equally, the augmented image Augₘᵢₓᵤₚ (xᵢ, xⱼ) is the most far away from the clean distribution. On the other hand, when y→0, the augmented image is close to the original image. Hence, the distance bucket Sₙ for each augmented example Augₘᵢₓᵤₚ (xᵢ, xⱼ) can be defined as: Sₙ=S_{2N·(min(γ,1-γ))}.

Example Update Labels

To learn the labels for the augmented training image within the distance bucket Sₙ, AutoLabel constructs an augmented validation set Q(Sₙ) by randomly mixing two images from validation data with a mixing parameter γ′ that is sampled from a uniform distribution:

$${γ}^{′} \text{∼} 𝒰 ( \frac{n}{2 N} , \frac{n + 1}{2 N} )$$

and γ′∈[0,0.5]. Unlike example applications of Augmix, there are two classes yᵢ and yⱼ existing in the augmented image Augₘᵢₓᵤₚ (xᵢ, xⱼ). Due to γ′∈[0,0.5], the class in the image xⱼ plays a dominant role in determining the main class in Augₘᵢₓᵤₚ (xᵢ, xⱼ). Therefore, example implementations follow Eqn (1) to update the label \tilde{y}_{k=y}_{ⱼ} for the class k=yⱼ. Unlike Eqn (3) that uniformly distributes the probability 1−\tilde{y}_{k=y}_{ⱼ} to all other classes, example implementations update the label for the class

$$k = {y}_{i} as {\tilde{y}}_{k = {y}_{i}} = min ( 1 - {\tilde{y}}_{k = {y}_{j}} , \frac{1 - {γ}^{′}}{{γ}^{′}} {\tilde{y}}_{k = {y}_{j}} )$$

and then distribute the probability 1−\tilde{y}_{k=y}_{ᵢ}−\tilde{y}_{k=y}_{ⱼ} to all other K−2 classes. Finally, the model is trained by minimizing the cross-entropy loss in Eqn (4) with the new labels \tilde{y} learned by AutoLabel as the target.

### Example AutoLabel for Adversarial Training

Example Overview of Adversarial Training

Adversarial training can be formulated as solving the min-max problem:

$${min}_{w} {𝔼}_{{‖ δ ‖}_{∞} \leq ɛ} [ max ℒ ( f ( x + δ ; w ) , y ) ] \qquad ( 7 )$$

where δ denotes the adversarial perturbation, ε denotes the maximum [symbol] _{∞} norm and a one-hot encoding of the label y is used as the target for the cross-entropy loss [symbol] . In, the inner maximization problem is approximately solved by generating projected gradient descent (PGD) attacks. Therefore, adversarial training can be considered as a specific data augmentation that aims for improving model's adversarial robustness.

Example Transformation Distance

First, AutoLabel differentiates the adversarial examples according to the distance between the adversarial examples and clean data. In adversarial training, the distance is approximately captured by the [symbol] _{∞} norm of the adversarial perturbation ε. Unlike, example implementations randomly sample ε from a uniform distribution ε˜ [symbol] (0,εₘₐₓ) to construct PGD adversarial attacks during training. If the [symbol] _{∞} norm of the adversarial perturbation is bounded by ε, then for those constructed adversarial examples, example implementations can determine their distance bucket Sₙ as:

$${S}_{n} = {S}_{ɛ \frac{N}{{ɛ}_{max}}} .$$

Example Update Labels

To learn the labels for adversarial examples within a distance bucket Sₙ to the clean data, AutoLabel constructs adversarial examples for the validation set by optimizing the inner maximization problem in Eqn (7) bounded by [symbol] _{∞} norm ε′, where ε′ is randomly sampled from a uniform distribution:

$${ɛ}^{′} \text{∼} 𝒰 ( \frac{n \cdot {ɛ}_{max}}{N} , \frac{( n + 1 ) \cdot {ɛ}_{max}}{N} ) .$$

Then example implementations can update the training labels \tilde{y} for adversarial examples following Eqn (1) and (3) and train the model using Eqn (4).

### Example Devices and Systems

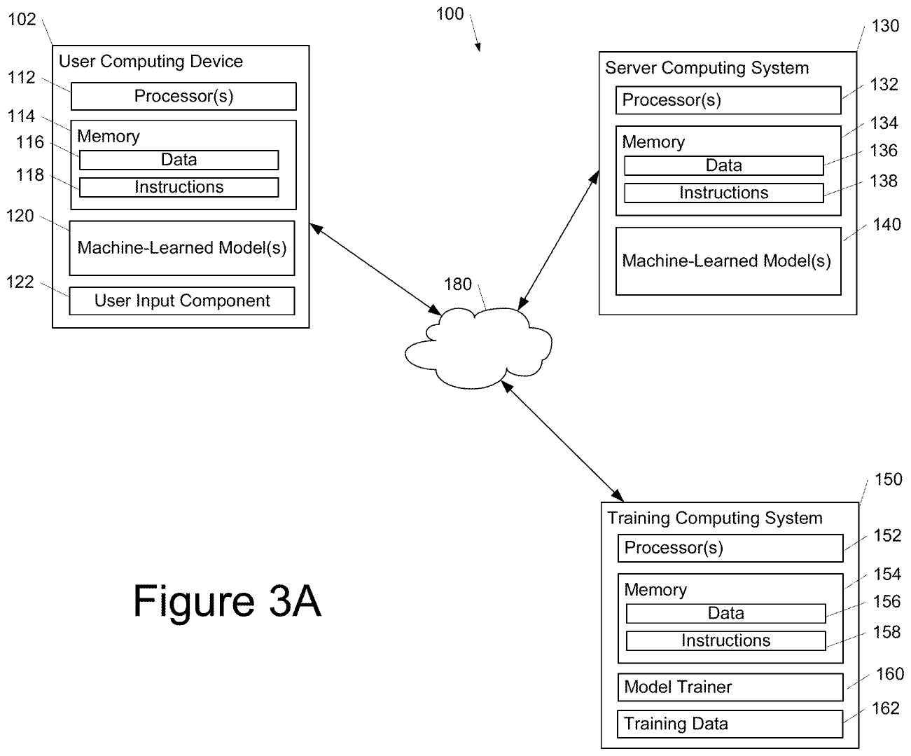

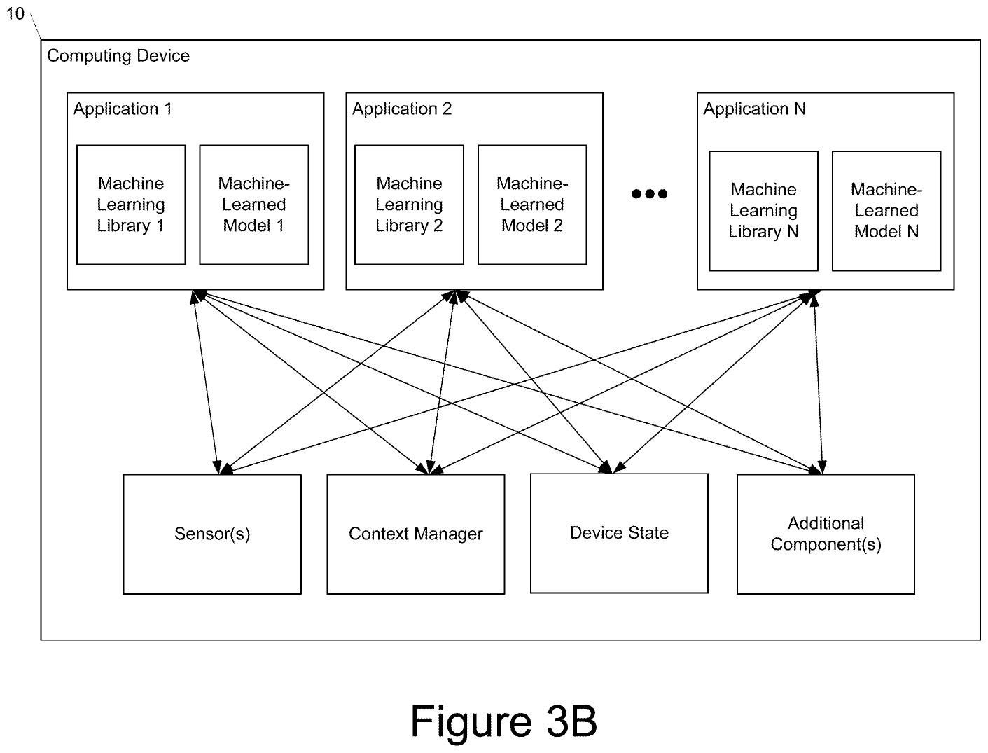

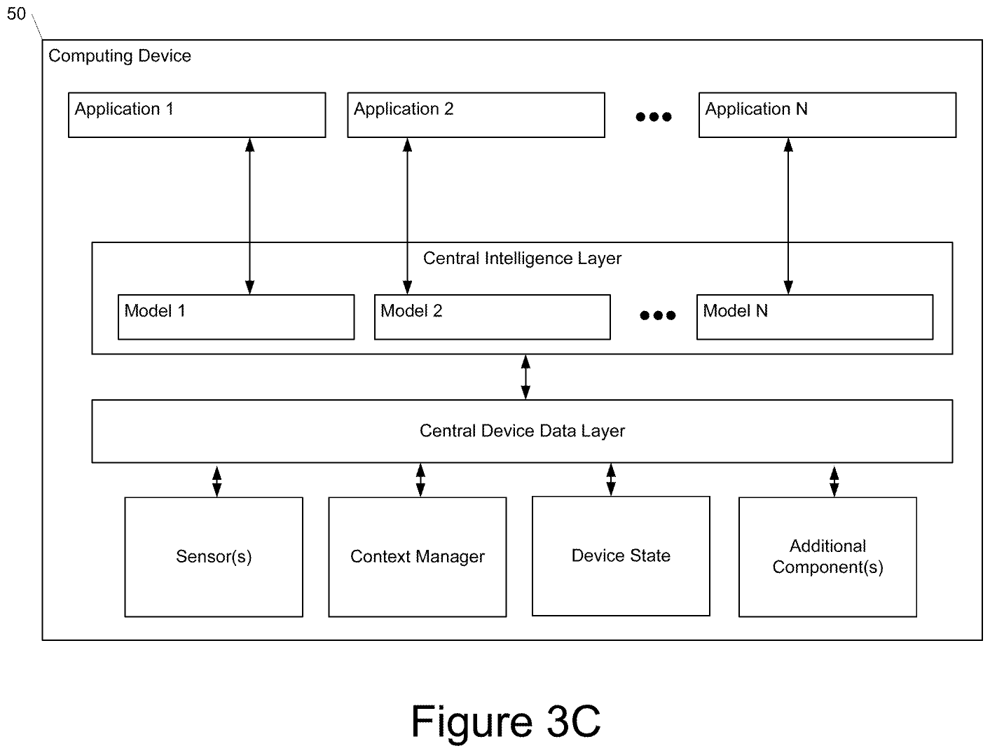

FIG. 3A depicts a block diagram of an example computing system 100 that performs automatic label smoothing of augmented examples according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120.

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service. Thus, one or more models 120 can be stored and implemented at the user computing device 102 and/or one or more models 140 can be stored and implemented at the server computing system 130.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, clean training data and augmented training data.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media. The model trainer 160 can perform the operations, processes, or methods shown in FIG. 1 and/or FIG. 2.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be three-dimensional data such as, for example, one or more LiDAR point clouds. The machine-learned model(s) can process the three-dimensional data to generate an output. As an example, the machine-learned model(s) can process the three-dimensional data to generate an recognition output (e.g., a recognition of the three-dimensional data, a latent embedding of the three-dimensional data, an encoded representation of the three-dimensional data, a hash of the three-dimensional data, etc.). As another example, the machine-learned model(s) can process the three-dimensional data to generate a three-dimensional data segmentation output. As another example, the machine-learned model(s) can process the three-dimensional data to generate a three-dimensional data classification output. As another example, the machine-learned model(s) can process the three-dimensional data to generate an three-dimensional data modification output (e.g., an alteration of the three-dimensional data, etc.). As another example, the machine-learned model(s) can process the three-dimensional data to generate an encoded three-dimensional data output (e.g., an encoded and/or compressed representation of the three-dimensional data, etc.). As another example, the machine-learned model(s) can process the three-dimensional data to generate an upscaled three-dimensional data output. As another example, the machine-learned model(s) can process the three-dimensional data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be audio compression task. The input may include audio data and the output may comprise compressed audio data. In another example, the input includes visual data (e.g. one or more image or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 3A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 3B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 3B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 3C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 3C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 3C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for automatic label smoothing of augmented training data to enable improved robustness of machine learning models, the method comprising:
obtaining, by a computing system comprising one or more computing devices, a plurality of augmented examples, wherein each augmented example comprises a training label, wherein a first subset of the augmented examples are included in a training dataset and a second subset of the augmented examples are included in a validation dataset, wherein a respective distance measure is associated with each augmented example, and wherein the respective distance measure for each augmented example describes an amount of augmentation performed to generate the augmented example;
partitioning, by the computing system, the plurality of augmented examples into a plurality of groups based on their respective distance measures; and
for each of one or more training iterations:
evaluating, by the computing system, a respective calibration value for each group that describes a calibration of a machine-learned model relative to the augmented examples included in the validation dataset and the group; and
smoothing, by the computing system, the training label of each augmented example included in the training dataset by a respective smoothing amount that is based at least in part on the respective calibration value evaluated for the group in which the augmented example is included.

2. The computer-implemented method of claim 1, further comprising, for each of the one or more training iterations:
re-training, by the computing system, the machine-learned model using the smoothed training labels for the augmented examples included in the training dataset.

3. The computer-implemented method of claim 1, wherein evaluating, by the computing system and for each group, the respective calibration value for each group comprises evaluating, by the computing system and for each group, a respective Expected Calibration Error metric.

4. The computer-implemented method of claim 1, wherein each training label comprises a plurality of label values respectively for a plurality of output classes, and wherein smoothing, by the computing system, the training label of each augmented example included in the training dataset comprises modifying, by the computing system, the label value for a true class of the plurality of output classes by the respective smoothing amount.

5. The computer-implemented method of claim 4, wherein the respective smoothing amount for each augmented example included in the training dataset comprises the respective calibration value evaluated for the group in which the augmented example is included times a scaling coefficient times a sign function applied to a confidence measure evaluated for the group minus an accuracy measure evaluated for the group.

6. The computer-implemented method of claim 1, further comprising, for each of the one or more training iterations:
performing, by the computing system, a clipping operation to ensure that the smoothed training label for each augmented example included in the training dataset is within a range extending from an accuracy measure evaluated for the group in which the augmented example is included to one.

7. The computer-implemented method of claim 1, wherein a number of the plurality of groups comprises a user-specified hyper-parameter.

8. The computer-implemented method of claim 1, wherein the respective distance measure for each augmented example comprises a number of augmentation operations performed to generate the augmented example.

9. The computer-implemented method of claim 1, wherein the respective distance measure for each augmented example comprises a mixing parameter that controls an amount of mixing between two inputs that are combined to generate the augmented example.

10. The computer-implemented method of claim 1, wherein the respective distance measure for each augmented example comprises a norm of an adversarial perturbation performed to generate the augmented example.

11. The computer-implemented method of claim 1, wherein smoothing, by the computing system, the training label of each augmented example included in the training dataset comprises:
reducing, by the computing system, a label value provided by the training label for a true class when the machine-learned model is overconfident on the validation dataset; and
increasing, by the computing system, the label value provided by the training label for the true class when the machine-learned model is underconfident on the validation dataset.

12. A computing system to perform automatic label smoothing of augmented training data to enable improved robustness of machine learning models, the computing system comprising:
one or more processors; and
one or more non-transitory computer-readable media that collectively store instructions that, when executed by the one or more processors, cause the computing system to perform operations, the operations comprising:
obtaining, by a computing system comprising one or more computing devices, a plurality of augmented examples, wherein each augmented example comprises a training label, wherein a respective distance measure is associated with each augmented example, and wherein the respective distance measure for each augmented example describes an amount of augmentation performed to generate the augmented example;
partitioning, by the computing system, the plurality of augmented examples into a plurality of groups based on their respective distance measures; and
for each of one or more training iterations:
evaluating, by the computing system, a respective calibration value for each group that describes a calibration of a machine-learned model relative to augmented examples included in the group; and
smoothing, by the computing system, the training label of each of one or more of the augmented examples by a respective smoothing amount that is based at least in part on the respective calibration value evaluated for the group in which the augmented example is included.

13. The computing system of claim 12, wherein the operations further comprise, for each of the one or more training iterations:
re-training, by the computing system, the machine-learned model using the smoothed training labels for the augmented examples.

14. The computing system of claim 12, wherein evaluating, by the computing system and for each group, the respective calibration value for each group comprises evaluating, by the computing system and for each group, a respective Expected Calibration Error metric.

15. The computing system of claim 12, wherein each training label comprises a plurality of label values respectively for a plurality of output classes, and wherein smoothing, by the computing system, the training label of each of the one or more augmented examples comprises modifying, by the computing system, the label value for a true class of the plurality of output classes by the respective smoothing amount.

16. The computing system of claim 15, wherein the respective smoothing amount for each augmented example included in the training dataset comprises the respective calibration value evaluated for the group in which the augmented example is included times a scaling coefficient times a sign function applied to a confidence measure evaluated for the group minus an accuracy measure evaluated for the group.

17. The computing system of claim 12, wherein the operations further comprise, for each of the one or more training iterations:
performing, by the computing system, a clipping operation to ensure that the smoothed training label for each augmented example is within a range extending from an accuracy measure evaluated for the group in which the augmented example is included to one.

18. The computing system of claim 12, wherein the machine-learned model comprises an image classification model.

19. The computing system of claim 12, wherein the training label comprises a classification label.

20. One or more non-transitory computer-readable media that collectively store:
a machine-learned model that has been trained on a training dataset that includes a plurality of augmented examples having smoothed training labels; and
instructions that, when executed by one or more processors of a computing system, cause the computing system to execute the machine-learned model to produce one or more predictions;
wherein the smoothed training label for each augmented example was smoothed by a respective smoothing amount based on a calibration metric evaluated for the machine-learned model relative to augmented examples included in a same group of a plurality of groups; and
wherein the plurality of groups are defined based on respective distance measures for the augmented examples that describe an amount of augmentation performed to generate the augmented example.
